(19) United States
(12) Patent Application Publication
(10) Pub. No.: US 2023/0221212 A1
(43) Pub. Date: Jul. 13, 2023

(54) Haptic Actuation Based Damage Detection

(71) Applicant: Lenovo (United States) Inc., Morrisville, NC (US)

(72) Inventors: Kevin Beck, Raleigh, NC (US); Robert James Norton, JR., Raleigh, NC (US); Thorsten Stremlau, Morrisville, NC (US)

(21) Appl. No.: 17/570,520

(22) Filed: Jan. 7, 2022

(51) Int. Cl. G01M 7/02

(52) U.S. Cl. CPC G01M 7/025

(57) ABSTRACT

A computer implemented method includes initiating vibration of a device via a vibrator built into the device. receiving vibration signals from a vibration detecting sensor built into the device, comparing the vibration signals to a reference vibration record, and generating an output identifying a device structural integrity based on the comparing.

### BACKGROUND

Discovering and evaluating physical damage to a device, such as a notebook computer or mobile phone, is a key element of assessing the viability of the device when it is being sold or returned at the end of useful life or a lease period. Item by item manual inspection is labor intensive and does not necessarily discover structural damage inside the system that is not externally visible. Disassembly of devices to assess structural integrity or damage in determining the viability of continued operation of the device is time consuming and expensive.

### SUMMARY

A computer implemented method includes initiating vibration of a device via a vibrator built into the device, receiving vibration signals from a vibration detecting sensor built into the device, comparing the vibration signals to a reference vibration record, and generating an output identifying a device structural integrity based on the comparing.

### BRIEF DESCRIPTION OF THE DRAWINGS

FIG. 1 is a block diagram of a device having an internal vibrator for use in testing device structural integrity according to an example embodiment.

FIG. 2 is a flowchart illustrating a computer implemented method of checking the structural integrity of a device using vibrations provided by an internal vibrator according to an example embodiment.

FIG. 3 is a flowchart illustrating a computer implemented method of ensuring a reference vibration record corresponds to a current configuration of a device according to an example embodiment.

FIG. 4 is a block schematic diagram of a computer system to implement one or more example embodiments.

### DETAILED DESCRIPTION

In the following description, reference is made to the. accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like, For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not. storage media, may additionally include communication media such as transmission media for wireless signals and the like.

Prior structural integrity analysis of objects has involved the used an external application of a mechanism to induce vibration in the objects. Similarly, an external sensor has been used to measure vibration of the object which is then compared to known vibrations associated with various levels of structural integrity. The comparison can reveal whether or not the object has structural integrity or is defective.

In various examples of the present inventive subject matter, the structural integrity of an electronic device, such as a laptop or cellular phone may be determined by activating a built-in device that vibrates in combination with one or more built in sensors to measure vibration of the electronic device. Haptic actuation of the built-in device initiates non-destructive forced vibration of the device which can be measured to detect physical damage of the device. The measured vibration may be compared to a reference vibration to determine whether or not the electronic device is structurally sound.

The sensors may include one or more accelerometers or microphones, or both, that provide signals representative of vibrations over a selected range of frequencies. The signals may be divided into frequency bands, with a measure of power for each band. The sensors may be distributed within the device to provide a vibration signals corresponding to different locations within the device, effectively providing patterns of vibration corresponding to the different locations. The reference vibration may be similarly mapped to the device and may include ranges of power within different bands of frequencies for each of the one or more sensors.

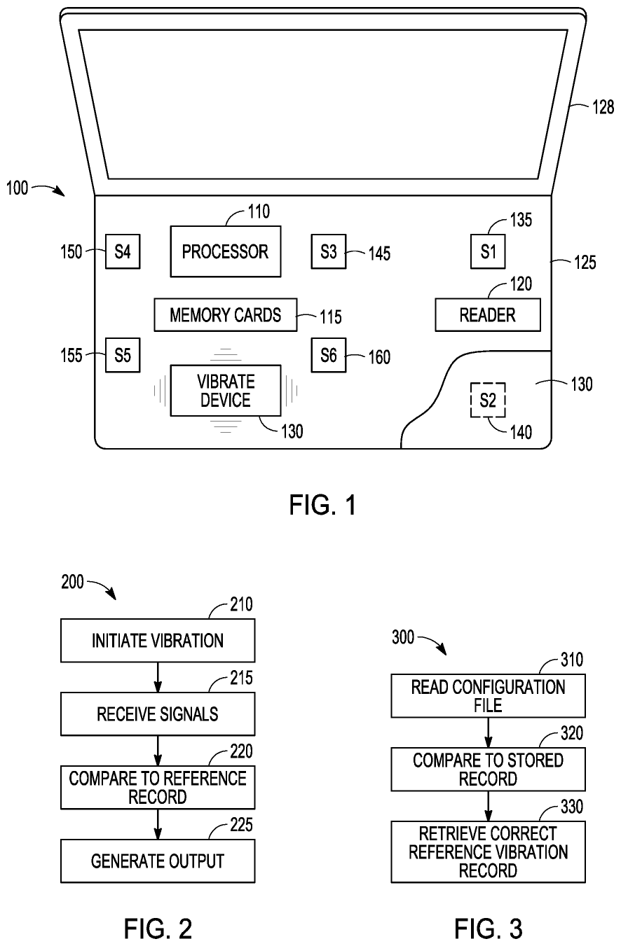

FIG. 1 is a block diagram of a device 100. Device 100 may be any type of device which may become damaged, resulting in a need for potential return or replacement. Device 100 may be an electronic device, such as a cellular phone or laptop computer. Such devices may be dropped and prone to damage, either to a case, electronics within the case, screen damage, or other damage.

In one example, device 100 may be a computer that includes one. or more of a processor 110, memory cards 115, a reader 120 for an external memory device, or other devices such as network cards. Device 100 as shown is representative of and may include a base 125 on which components may be supported, a top cover 126 for enclosing components between the base 125 and cover 126. Only a portion of the cover 12.6 is shown for ease of illustration, but the cover may cover the entire surface area of the base to fully enclose the components. Device 100 may include a display screen 128 which may be hinged to the base 125 in the case of a laptop computer or integrated into the top cover 126 in the case of a cellular phone.

In one example, a vibrator device 130 is supported within the device 100. The vibrator device 130 may be a haptic motor that is attached to the base for providing haptic feedback to users of the device. The vibrator device may be actuated to provide haptic feedback by one or more applications executing on the processor 110. Phone calls may trigger the vibrate device 130 such that the device 100 vibrates in a manner perceivable to a user.

Such vibrations may also be initiated to check the structural integrity of the device 100 during testing. The entire device may vibrate in response to actuation of the vibrator device 130. The vibrator device 130 may be a haptic motor in one embodiment. The haptic motor may operate by rotating an eccentric mass in one example or may be a linear resonant actuator. Any type of vibrating device that provide consistent vibrations with consistent energy may be used.

One or more sensors S1 135, S2 140, S3 145, S4 150, S5 155, and S6 160 may be disposed within the device at different locations of the device. The sensors may include one or more of accelerometers and microphones, as vibrations may include physical vibrations of the device sensed by accelerometers and resulting vibration of the air within the device sensed by the microphones. The resulting sensed vibrations may be referred to as a pattern of vibrations representative of different sensed vibrations at the different locations within the device. The vibrations are the result of the device's mass, dampening, stiffness, and inherent natural frequencies/vibration modes of the of the components of the device.

On manufacture of the device, the vibrator device 130 may be activated and the sensed vibrations recorded to model the device by generating a reference vibration record, also referred to as a vibration model. A configuration of the device may also be associated with the reference vibration record. Various devices with different configurations may be activated with corresponding reference vibration records associated with the respective configurations to create a library of vibration models for multiple different configurations. The reference vibration records may include sensed vibrations from one or more sensors in each device.

In one example, the vibration record may comprise power levels for each of multiple bands of frequencies for devices that are known to have structural integrity. For each configuration, multiple devices may also be tested so that a range of frequencies for each band may be included in the reference vibration records.

Testing may include destructive testing, such as by dropping the devices or otherwise causing physical damage to the device, such as a cracked base, broken memory card, or other structural defect which can be visually identified. Such devices with known undesired structural defects may also he vibrated with the vibrate device provided the vibrate device is still operational. Recording of the sensed vibrations may be used to help adjust the ranges of power for each of the frequency bands in the reference vibration records to ensure that the ranges of power are not broad enough to include vibrations of devices that have undesired structural defects,

The reference vibrations records or model form a baseline “signature” (vibration patterns and sounds) of all the possible device configurations captured and recorded from devices before and after testing, Such capturing may he used to establish ranges of power for the frequency bands for each configuration to account for differences between configurations and between freshly manufactured systems and those having undergone stress testing,

These signatures may be stored externally for future reference or stored in non-volatile memory/BIOS of the device. If externally stored, testing software/firmware used to initiate a structural integrity test uses the MTM/BIOS hardware descriptors of the device to find the baseline signature corresponding to the device's particular configuration

The testing software/firmware may check the original MTM/configuration information for the device against the current configuration to determine if components had been added to or removed from the system and then adjust/replace the baseline signature as appropriate.

If internally stored, the testing software/firmware retrieves the signature and checks for configuration changes. The testing software/firmware then initiates a forced vibration testing of the system by actuating the vibrator device 130. Ideally, the vibrator device vibrates at a stable fixed rate and energy. The sensed vibration power levels in each band are recorded and compared to the original signature to make a determination (via an algorithm or neural network) of possible structural damage/cracks/loose screws or ports/etc. The algorithm may check to see if the power in any one or more bands of frequencies is outside of the range.

In some examples, a component of the device that is structurally sound may be known to vibrate at a resonant frequency. Lack of power in that frequency band may he indicative that the component is faulty or structurally unsound. Excess power in other bands may also be indicative of a faulty or structurally unsound part of the device. The knowledge of the resonant frequency of each component can aid in diagnosing a structural defect in the device without having to open the device for visual inspection, which can save significant time in triaging devices for repair or replacement.

FIG. 2 is a flowchart illustrating a computer implemented method 200 of checking the structural integrity of a device using vibrations provided by an internal vibrator. Method 200 may he performed by testing software executing on a test system coupled to the device or may be executed by the device itself. Method 200 begins at operation 210 by initiating vibration of the device via a vibrator built into the device. The vibrator may he a haptic motor for example. Vibration signals are received at operation 220 from a vibration detecting sensor built into the device. The vibration sensor may comprise one or more of accelerometers and microphones.

The received vibration signals are compared at operation 230 to a reference vibration record. The reference vibration record is a baseline vibration signature of the device in a condition known to be structurally sound. In one example, the reference vibration record is obtained by reading a configuration file of the device to obtain a current configuration of the device and selecting the reference vibration record from a plurality of reference vibration records as a function of the configuration file.

At operation 240, an output is generated identifying a device structural integrity based on the comparison of the received vibration signals to the reference vibration record. The output may be a simple pass or fail indication. The fail indication may cause initiation of disassembly of the device to determine the actual physical damage.

FIG. 3 is a flowchart illustrating a computer implemented method 300 of ensuring the reference vibration record corresponds to a current configuration of the device. Method 300 begins at operation 310 by reading a configuration file of the device to obtain a current configuration of the device. At operation 320, the current configuration file is compared to a configuration associated with a reference vibration record stored on the device. In response to the current configuration file not matching the configuration associated with the reference vibration record stored on the device, a reference vibration record corresponding to the current configuration identified in the current configuration file is identified at operation 330 prior to comparing the vibration signals to the reference vibration record corresponding to the current configuration.

The reference vibration records comprise a vibration record for each of multiple different device configurations. The device may be a computer which may be manufactured with, or later modified to have different configurations, such as different amounts of memory, cards, and readers.

In one example, the reference vibration record comprises a vibration model representative of vibration patterns sensed by multiple vibration sensors. The vibration sensor may include multiple vibration sensors that are disposed at different locations within the device. The vibration patterns are representative of vibration power in multiple frequency bands at each sensor location within the device.

The reference vibration model includes a range of power levels at different frequencies and wherein comparing is performed by comparing corresponding power levels at the different frequency bands that are present in the received vibration signals to the ranges. An algorithm may be used to determine vibrations outside ranges in one or more bands.

In further examples, a machine learning model may be trained based on based on labeled vibration patterns to detect whether or not an input vibration pattern is representative of a device with structural integrity. Training data may include configuration data and vibration patterns for both devices with and withing structural integrity. The training data may be labeled with an indication of the structural integrity in one example, training data may include vibration patterns of device having known defects, and the labels for such device may identify both the lack of structural integrity as well as an identification of the known defect. The output 240 may then indicate the source of the physical damage of the device.

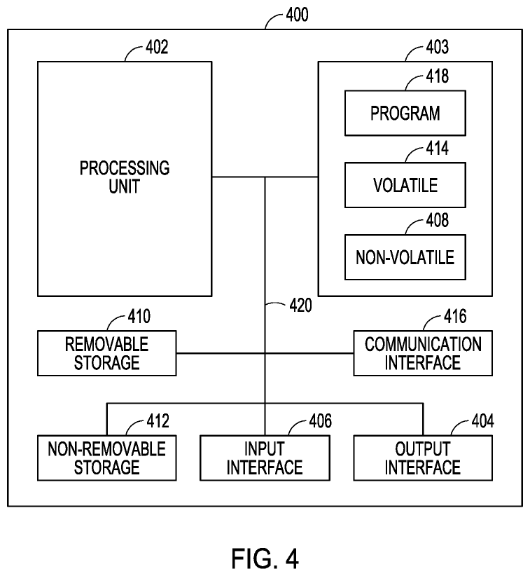

FIG. 4 is a block schematic diagram of a computer system 400 representative of both a device to be tested as well as a device to perform testing using non-destructive internally generated haptic vibrations and for performing methods and algorithms according to example embodiments. All components need not be used in various embodiments.

One example computing device in the form of a computer 400 may include a processing unit 402, memory 403, removable storage 410, and non-removable storage 412. Although the example computing device is illustrated and described as computer 400, the computing device may he in different forms in different embodiments. For example, the computing device may instead he a smartphone, a tablet, smartwatch, smart storage device (SSD), or other computing device including the same or similar elements as illustrated and described with regard to FIG. 4. Devices, such as smartphones, tablets, and smartwatches, are generally collectively referred to as mobile devices or user equipment.

Although the various data storage elements are illustrated as part of the computer 400, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 403 may include volatile memory 414 and non-volatile memory 408. Computer 400 may include or have access to a computing environment that includes—a variety of computer-readable media, such as volatile memory 414 and non-volatile memory 408, removable storage 410 and non-removable storage 412. Computer storage includes random access memory (RAM), read only memory (ROW, erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 400 may include or have access to a computing environment that includes input interface 406, output interface 404, and a communication interface 416. Output interface 404 may include a display device, such as a touchscreen, that also may serve as an input device. The input interface 406 may include one or more of a touchscreen, touchpad, mouse, keyboard, camera, one or more device-specific buttons, one or more sensors integrated within or coupled via wired or wireless data connections to the computer 400, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 400 are connected with a system bus 420.

Computer-readable instructions stored on a computer-readable medium are executable by the processing unit 402 of the computer 400, such as a program 418. The program 418 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 418 along with the workspace manager 422 may be used to cause processing unit 402 to perform one or more methods or algorithms described herein.

### EXAMPLES

1. A computer implemented method includes initiating vibration of a device via a vibrator built into the device, receiving vibration signals from a vibration detecting sensor built into the device, comparing the vibration signals to a reference vibration record, and generating an output identifying a device structural integrity based on the comparing.

2. The method of example 1 wherein the vibrator includes a haptic motor.

3. The method of any of examples 1-2 wherein the reference vibration record includes a baseline vibration signature of the device in a condition known to be structurally sound.

4. The method of any of examples 1-3 and further including accessing a current configuration file stored on the device, comparing the current configuration file to a configuration associated with a reference vibration record stored on the device, and in response to the current configuration file not matching the configuration associated with the reference vibration record stored on the device, accessing a reference vibration record corresponding to the current configuration identified in the current configuration file prior to comparing the vibration signals to the reference vibration record corresponding to the current configuration.

5. The method of any of examples 1-4 and further including reading a configuration file of the device to obtain a current configuration of the device and selecting the reference vibration record from a plurality of reference vibration records as a function of the configuration file prior to comparing.

6. The method of example 5 wherein the reference vibration records include comprise a vibration record for each of multiple different device configurations.

7. The method of example 6 wherein the device includes a computer and where different configurations of the computer include different amounts of memory, cards, and readers.

8. The method of any of examples 1-7 wherein the initiating, receiving, comparing, and generating are performed by testing software.

9. The method of example 8 wherein the testing software is executed by a testing system communicatively coupled to the device.

10. The method of any of examples 1-9 wherein the reference vibration record includes a vibration model representative of vibration patterns,

11. The method of example 10 wherein the vibration sensor includes multiple vibration sensors that are disposed at different locations within the device and wherein the vibration patterns are representative of vibration power in multiple frequency bands at each sensor location within the device.

12. The method of any of examples 9-11 wherein the vibration sensors include accelerometers and microphones.

13. The method of any of examples 142 wherein the reference vibration model includes a range of power levels at different frequencies and wherein comparing is performed by comparing corresponding power levels at the different frequencies that are present in the received vibration signals to the ranges.

14. A machine-readable storage device has instructions for execution by a processor of a machine to cause the processor to perform operations to perform any of the methods of examples 1-13.

15. A device includes a processor and a memory device coupled to the processor and having a program stored thereon for execution by the processor to perform operations to perform any of the methods of examples 1-13.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
causing vibration of a device via a vibrator built into the device;
receiving vibration signals from a vibration detecting sensor built into the device;
comparing the vibration signals to a reference vibration record representative of a baseline vibration signature of the device; and
generating an output identifying a device structural integrity based on the comparing.

2. The method of claim 1 wherein the vibrator comprises a haptic motor.

3. The method of claim 1 wherein baseline vibration signature of the device includes vibration power at multiple frequencies corresponding to a condition known to be structurally sound.

4. The method of claim 1 and further comprising:
accessing a current configuration file stored on the device;
comparing the current configuration file to a configuration associated with a reference vibration record stored on the device; and
in response to the current configuration file not matching the configuration associated with the reference vibration record stored on the device, accessing a reference vibration record corresponding to the current configuration identified in the current configuration file prior to comparing the vibration signals to the reference vibration record corresponding to the current configuration.

5. The method of claim 1 and further comprising:
reading a configuration file of the device to obtain a current configuration of the device; and
selecting the reference vibration record from a plurality of reference vibration records as a function of the configuration file prior to comparing.

6. The method of claim 5 wherein the reference vibration records comprise a vibration record for each of multiple different device configurations.

7. The method of claim 6 wherein the device comprises a computer and where different configurations of the computer include different amounts of memory, cards, and readers.

8. The method of claim 1 wherein the causing, receiving, comparing, and generating are performed by testing software.

9. The method of claim 8 wherein the testing software is executed by a testing system communicatively coupled to the device.

10. The method of claim 1 wherein the reference vibration record comprises a vibration model representative of vibration patterns.

11. The method of claim 10 wherein the vibration sensor comprises multiple vibration sensors that are disposed at different locations within the device and wherein the vibration patterns are representative of vibration power in multiple frequency bands at each sensor location within the device.

12. The method of claim 11 wherein the vibration sensors comprise accelerometers and microphones.

13. The method of claim 11 wherein the reference vibration model includes a range of power levels at different frequencies and wherein comparing is performed by comparing corresponding power levels at the different frequencies that are present in the received vibration signals to the ranges.

14. A machine-readable storage device having instructions for execution by a processor of a machine to cause the processor to perform operations to perform a method, the operations comprising:
causing vibration of a device via a vibrator built into the device;
receiving vibration signals from a vibration detecting sensor built into the device;
comparing the vibration signals to a reference vibration record representative of a baseline vibration signature of the device; and
generating an output identifying a device structural integrity based on the comparing.

15. The device of claim 14 wherein the vibrator comprises a haptic motor and wherein the reference baseline vibration signature of the device includes vibrations at multiple frequencies corresponding to a condition known to be structurally sound.

16. The device of claim 14 and further comprising:
accessing a current configuration file stored on the device;
comparing the current configuration file to a configuration associated with a reference vibration record stored on the device; and
in response to the current configuration file not matching the configuration associated with the reference vibration record stored on the device, accessing a reference vibration record corresponding to the current configuration identified in the current configuration file prior to comparing the vibration signals to the reference vibration record corresponding to the current configuration.

17. The device of claim 14 and further comprising:
reading a configuration file of the device to obtain a current configuration of the device; and
selecting the reference vibration record from a plurality of reference vibration records as a function of the configuration file prior to comparing.

18. The device of claim 17 wherein the vibration sensor comprises multiple vibration sensors that are disposed at different locations within the device and wherein the vibration patterns are representative of vibration power in multiple frequency bands at each sensor location within the device.

19. The device of claim 14 wherein the reference vibration model includes a range of power levels at different frequencies and wherein comparing is performed by comparing corresponding power levels at the different frequencies that are present in the received vibration signals to the ranges.

20. A device comprising:
a processor; and
a memory device coupled to the processor and having a program stored thereon for execution by the processor to perform operations comprising:
causing vibration of a device via a vibrator built into the device;
receiving vibration signals from a vibration detecting sensor built into the device;
comparing the vibration signals to a reference vibration record representative of a baseline vibration signature of the device; and
generating an output identifying a device structural integrity based on the comparing.
